(19) United States
(12) Patent Application Publication
(10) Pub. No.: US 2011/0313846 A1
(43) Pub. Date: Dec. 22, 2011

(54) INCLUDING PERSONALIZED CONTENT IN AN ADVERTISEMENT

(75) Inventors: PRITESH PATWA, REDMOND, WA (US); WOOK CHUNG, KIRKLAND, WA (US); MARTIN MARKOV, REDMOND, WA (US)

(73) Assignee: MICROSOFT CORPORATION, REDMOND, WA (US)

(21) Appl. No.: 12/816,847

(22) Filed: Jun. 16, 2010

(51) Int. Cl. G06Q 30/00; G06Q 99/00; G06F 9/46

(52) U.S. Cl. 705/14.43; 705/14.53; 705/14.67; 719/328

(57) ABSTRACT

The present invention is directed to personalizing an advertisement. In an exemplary embodiment, ad-rendering instructions are received that, when executed, prompt retrieval of user-specific information (e.g., profile images, birthdays, anniversaries, etc.) of a user. The user-specific information might be retrieved from an online-service provider, such as an email-exchange-service provider, a social-network provider, or an e-commerce-service provider. An advertisement is customized to reflect the user-specific information, thereby creating a personalized advertisement, which is rendered to the user.

### BACKGROUND

An online ad is often selected to be presented to a user based on a prediction that the ad will be relevant to the user. For example, the ad might be selected based on a keyword included among content of a webpage requested by the user. The ad might also be selected based on prior activities (e.g., browsing history) of the user. However, typically content of the ad has no particular relevance to the user. For example, the user typically does not personally know an individual presented in the advertisement. Customizing an ad by including content having a personal connection to the user often makes the ad more relevant.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section. This summary is not intended to identify key features or essential features of the claimed subject matter, nor is it intended to be used as an aid in isolation to determine the scope of the claimed subject matter.

The present invention is directed to personalizing an advertisement. In an exemplary embodiment, ad-rendering instructions are received that, when executed, prompt retrieval of user-specific information (e.g., profile images, birthdays, anniversaries, etc.) of a user. The user-specific information is retrieved from a user-information datastore, such as a datastore maintained by an email-exchange-service provider, a social-network provider, or an e-commerce-service provider. An advertisement is customized to reflect the user-specific information, thereby creating a personalized advertisement, which is rendered to the user.

### BRIEF DESCRIPTION OF THE DRAWINGS

Illustrative embodiments of the present invention are described in detail below with reference to the attached drawing figures, wherein:

FIG. 1 is a block diagram depicting an exemplary computing device suitable for use in accordance with embodiments of the invention;

FIG. 2 is a block diagram of an exemplary operating environment in accordance with an embodiment of the present invention; and

FIG. 3 is an exemplary flow diagram in accordance with an embodiment of the present invention.

### DETAILED DESCRIPTION

The subject matter of embodiments of the present invention is described with specificity herein to meet statutory requirements. But the description itself is not intended to necessarily limit the scope of the claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly stated.

Generally, embodiments of the present invention are directed to personalizing an advertisement to be presented to a user. That is, pursuant to the present invention, advertisers have the ability to program an advertisement to reflect user-specific information (e.g., image, date, preferences, favorites, and relationships). In one embodiment, ad-rendering instructions executed by a client device enable the client device to retrieve the user-specific information from a user-information datastore, such that the ad functions as a client-side application. When the user-specific information is retrieved by, and subsequently rendered on the client device, privacy can be maintained. For example, privacy related to a family member's image and birthday is maintained when the image and date are communicated to, and presented by, the client device and are not shared with an advertiser.

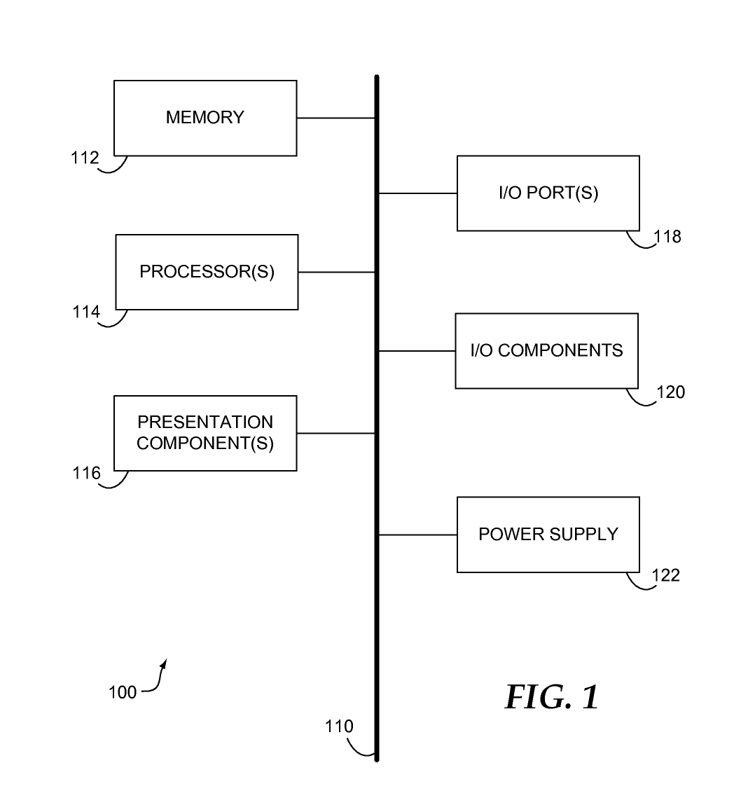

Having briefly described embodiments of the present invention, we refer now to FIG. 1 in which an exemplary operating environment for implementing embodiments of the present invention is shown and designated generally as computing device 100. Computing device 100 is but one example of a suitable computing environment and is not intended to suggest any limitation as to the scope of use or functionality of invention embodiments. Neither should the computing environment 100 be interpreted as having any dependency or requirement relating to any one or combination of components illustrated.

Embodiments of the invention might be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention might be practiced in a variety of system configurations, including handheld devices, consumer electronics, general-purpose computers, more specialty computing devices, etc. Embodiments of the invention might also be practiced in distributed computing environments where tasks are performed by remote-processing devices that are linked through a communications network.

Embodiments of the present invention may be embodied as, among other things: a method, system, or set of instructions embodied on one or more computer-readable media. Computer-readable media include both volatile and nonvolatile media, removable and nonremovable media, and contemplates media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

With reference to FIG. 1, computing device 100 includes a bus 110 that directly or indirectly couples the following devices: memory 112, one or more processors 114, one or more presentation components 116, input/output ports 118, input/output components 120, and a power supply 122. Bus 110 represents what might be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. By way of example, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

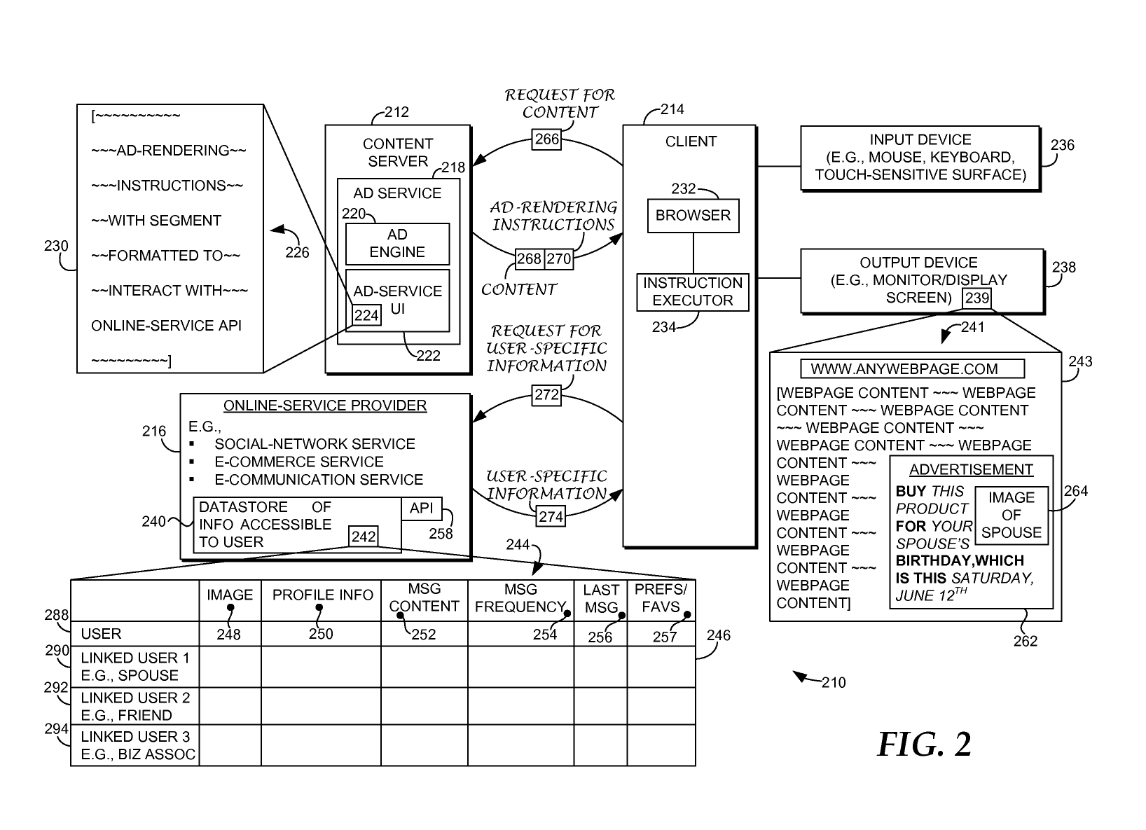

Referring now to FIG. 2, an exemplary operating environment suitable for practicing an embodiment of the invention is depicted and identified generally by reference numeral 210. Environment 210 includes a content server 212, a client computing device 214, and an online-service provider 216. Elements 212, 214, and 216 communicate with one another using a network, such as the Internet. For example, client 214 might request content (e.g., a webpage), which is provided to the client 214 by content server 212. Likewise, client 214 might request content (e.g., a webpage) from online-service provider 216, and in response thereto, online-service provider 216 might send the content to client 214.

In an embodiment of the present invention, content server 212 includes an ad service 218 that enables a third party (e.g., retailer, restaurant, etc.) to create an advertisement, which is then served by content server 212 together with content to a content-requesting device (e.g., client 214). Ad service 218 is depicted in FIG. 2 as a subcomponent of content server 212; however, in other embodiments, ad service 218 and content server 212 include separate components that communicate with one another.

Ad service 218 includes an ad engine 220 and an ad-service user interface (UI) 222. Ad engine 220 functions to, among other tasks, select an advertisement to be sent to client device 214. For example, ad engine 220 might extract ad triggers (e.g., keywords) of a requested webpage, compare ad triggers to advertiser criteria, and hold an auction using advertiser bids. Ad-service UI 222 enables an advertiser to interact with ad service 218. For example, using ad-service UI 222, an advertiser can submit an advertisement to be served to a client, submit desirable ad triggers, and submit a bid to be paid in exchange for the advertisement being served. While FIG. 2 only depicts ad engine 220 and ad-service UI 222, ad service 218 might include other components as well, such as an analytics component that tracks advertisement rendering and user selection.

Ad-service UI 222 includes information 224 that is depicted in an exploded view 226 for illustrative purposes and that represents an advertisement submitted by an advertiser to ad service 218. In an embodiment of the present invention, the submitted advertisement includes ad-rendering instructions 230, which, when executed by a computing device (e.g., client 214), enable rendering (e.g., presentation) of the submitted advertisement. Ad-rendering instructions 230 will be described in more detail hereinafter below.

In a further embodiment of the present invention, client 214 includes a browser 232 (or any application that accesses the network), which communicates with an instruction executor 234. Moreover, client 214 is connected to an input device 236 (e.g., mouse, keyboard, touch-sensitive surface, etc.) and an output device 238 (e.g., monitor, screen, etc.). In an embodiment of the invention, input device 236 enables a user to submit commands to client 214 and interact with browser 232 via a user interface (not shown). One exemplary command that a user might submit prompts client 214 to request content from content server 212 or online-service provider 216. Client 214 might include various computing devices. For example, client 214 might include a desktop, laptop, gaming console, mobile device, or combination thereof.

In a further embodiment, browser 232 functions as a web browser that enables presentation on output device 238 of webpage content and advertising content, such as content provided by content server 212 and/or online-service provider 216. For example, output device 218 includes information 239, which is depicted in an exploded view 241 for illustrative purposes. Exploded view 241 depicts a webpage 243 (i.e., www.anywebpage.com) that might be presented using output device 238. Webpage 243 includes webpage content and an advertisement 262.

In another embodiment of the present invention, online-service provider 216 makes available to client 214 an online service, which is available using a network (not shown), such as the Internet. Exemplary online services include, social networking (e.g., Facebook®, Twitter®, MySpace®, LinkedIn®, etc.); email exchange (e.g., Hotmail® email services); instant-message exchange (e.g., Windows Live Messenger®); e-commerce (e.g., online retailers, Amazon.com®, Ebay.com®, etc.); e-banking service (e.g., online checking-account management and savings-account management); e-investing service (e.g., online trading); credit-account management (e.g., American Express®, Discover®, etc); and gaming/gaming network (e.g., Xbox®-related services).

Often, to allow a user of client 214 to utilize an online service, an online-service account is established for the user. Exemplary accounts include an email account, a social-network account, an instant-message account, an e-commerce account, an e-banking account, an e-investing account, a credit-card account, and a gaming account. In some embodiments, online services might be bundled, such that one online-service account allows a user to access more than one online service. For example, email-exchange services might be bundled with instant-message-exchange services and gaming services, such that only one account is required to access the email-exchange services, the instant-message-exchange services, and the gaming service.

In an embodiment of the present invention, when online services are utilized, the user gains access to user-specific information. For example, datastore 240 stores data 242, which is depicted in an exploded view 244 for illustrative purposes. Exploded view 244 depicts illustrative user-specific information 246 to which a user might have access when utilizing an online service. Exemplary user-specific information 246 includes information that describes the user, other linked users that are associated with the user, and communication metrics of the user and the linked users. For illustrative purposes, FIG. 2 generically depicts datastore 240 as singular; however, in other embodiments, datastore 240 includes a plurality of datastores. Moreover, although only one online-service provider 216 is depicted in FIG. 2, in an embodiment of the present invention, environment 210 includes a plurality of online-service providers, each of which maintains a respective user-information datastore. For example, a social-network provider might maintain a user-information datastore, which includes user-specific information that is accessible in connection with a social-network account. On the other hand, an email-service provider might maintain a separate user-information datastore, which includes user-specific information that is accessible in connection with an email account.

For illustrative purposes, user-specific information 246 is organized under categories, which include images 248, profile information 250, message contents 252, message-exchange frequency 254, duration since last message 256, and preferences/favorites 257. For example, a profile image, avatar, or other images that depict a user might be organized or stored under images 248. Moreover, profile information 250 might include various items that describe a user, such as age, gender, status, location, employer, occupation, relationship, spouse name, friends, birthdays, anniversaries, schools attended, and education. Often, such profile information 250 is received when a user establishes a user account; however, the profile information 250 might also be gathered by online-service provider 216 based on use of online services by a user. For example, profile information 250 might be gathered based on activities and transactions of a user. Message contents 252 might include content of messages that are exchanged between users. Messages can take various forms, such as postings on a linked user's blog or message board, email messages, instant messages, etc. Message-exchange frequency 254 indicates how often a user and a linked user exchange messages. For example, message-exchange frequency 254 might indicate that a user and a linked user exchange messages hourly, daily, or weekly. Duration since last message 256 includes information that describes how much time has passed since a user exchanged messages with a linked user. Preferences/favorites 257 might include a list of products, movies, songs, restaurants, or other subjects that a user has favorably listed. The categories of information depicted in FIG. 2 are merely illustrative and various other categories of information might also be accessible to a user when using online services, such as interests, contact information, related persons, social-network groups (e.g., State University Class of 2010), and third-party online content (e.g., multimedia file) stored in connection with a user's account.

User-specific information 246 also illustrates that relationships of users that are linked to the user might be stored as part of user-specific information 246. That is, in an exemplary embodiment, “linked user 1” 290 is a spouse of user 288, “linked user 2” 292 is a friend of user 288, and “linked user 3” 294 is a business associate of user 288. Such relationships might be expressly designated by a user and/or linked users. Moreover, such relationships might be inferable from activity of, and interaction between, the user and linked users.

In an embodiment of the present invention, online-service provider 216 makes available an application programming interface (“API”) 258, which allows other parties to leverage information in datastore 240. That is, by executing an application written pursuant to API 258, another computing device can utilize information stored in datastore 240. As such, using an embodiment of the present invention, an advertiser can pull information from any source (e.g., datastore of online-service provider) that is exposed by way of a respective API. In an alternative embodiment, ad-rendering instructions might not directly correlate with an API, such as when there is an abstraction between the ad-rendering instructions and the API. In such a scenario a generic intermediate layer of software might understand the API, and ad-rendering instructions merely interface with this application to retrieve the data.

In one embodiment, content server 212 executes a segment of instructions (i.e., code) that is formatted to interact with API 258, thereby enabling content server 212 to retrieve user-specific information 246 from online-service provider 216. Alternatively, client 214 might execute a segment of instructions formatted to interact with API 258, thereby enabling client 214 to retrieve user-specific information 246 from online-service provider 216. In one embodiment, API 258 is a social-network API, such as an API that allows leverage information to which a user has access on the Facebook® social network. In embodiments in which client 214 retrieves user-specific information, privacy is maintained since the user-specific information is not shared with either an advertiser or content server 212. That is, a user might have privacy concerns when an advertisement is displayed that includes user-specific information (e.g., an image of a family member); however, because the user-specific information is not coming from, and is not shared with, the advertiser, privacy can be maintained.

In a further embodiment, once user-specific information is received from an online-service provider, the user-specific information can be used as directed by the set of instructions. For example, client 214 includes an instructions executor 234, which receives user-specific information from online-service provider 216. Using instructions executor 234, user-specific information can be used in the generation of advertisement 262. In one embodiment, all received user-specific information might be incorporated into an advertisement. For example, if all received user-specific information includes one image or one item of text, that one image or one item of text might be incorporated into an advertisement. In another embodiment, user-specific information might require sorting and/or ranking before being used to generate a personalized advertisement. For example, an advertisement might include only one space that is fillable with an image and/or text, but the user-specific information might include more than one image or text that could be used to personalize the advertisement. In such a scenario, the user-specific information is sorted and/or ranked to determine which of the more than one image or text should be selected to fill the only one space.

In an embodiment of the present invention, the above-described environment 210 is utilized to carry out various functions, which enable an advertisement to be personalized. That is, environment 210 enables an advertisement 262 to be presented via output device 238, such that advertisement 262 reflects user-specific information 264 (e.g., picture of user's spouse). An advertisement might reflect user-specific information in a variety of ways. For example, the advertisement might visually depict the user-specific information (e.g., image, birthday, anniversary, names, etc.). Alternatively, a specific version of an advertisement might be selected that is customized towards an audience that has that user-specific information in common. For example, one version of an advertisement might target an audience of females over a threshold age, whereas another version of an advertisement might target an audience of females under the threshold age. In another example, a movie-ticket seller might submit alternative versions of an ad to come watch movies, such that: for parents with a son, the ad shows boys watching an action cartoon; for parents with a daughter, the ad shows girls watching a princess cartoon; and for parents with both sons and daughters, the ad shows boys and girls watching a cartoon about a pet dragon.

Moreover, environment 210 allows for ad personal customization, as an enhancement to ad targeting. That is, ad targeting merely selects a particular ad (e.g., ad to purchase a neck tie) and sends that particular ad to a user (e.g., male older than 25 years). On the other hand, ad personal customization allows an advertiser to create many alternatives pieces of content (e.g., images, text, etc.), combine desired content pieces with ad-rendering instructions, and show the ad to anyone. In this respect, the ad itself includes the alternatives and will figure out which content (e.g., image) is most relevant to the user. As a result, ad personal customization enhances ad-targeting services.

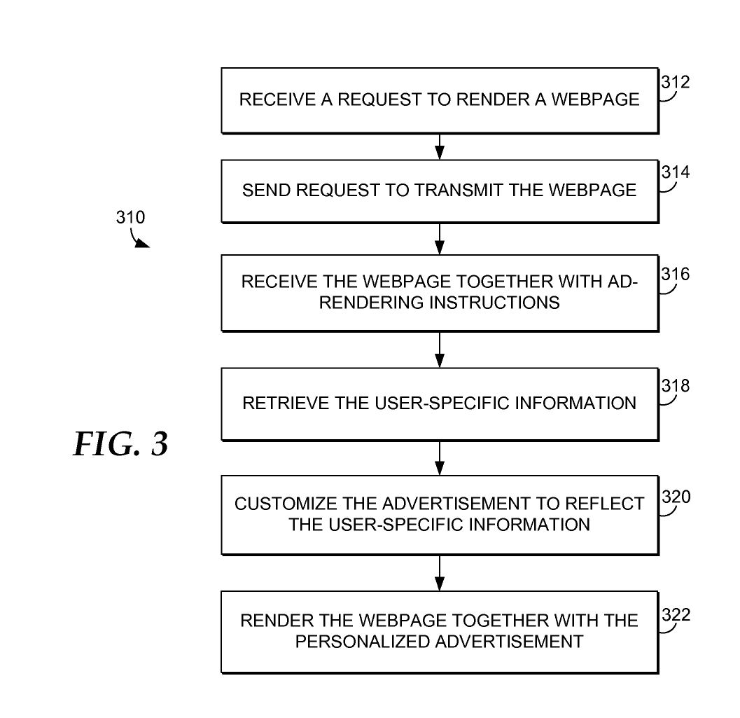

Referring now to FIG. 3, a flow diagram depicts a method 310 that is executable using components depicted in environment 210 of FIG. 2. In describing method 310, reference will be made to FIG. 2 for illustrative purposes. FIG. 3 includes at step 312, receiving a request to render a webpage. For example, using input device 236, a user might submit to client device 214 a request that a webpage be rendered on output device 238. Step 314 includes sending to a server a request to transmit the webpage. For example, client device 214 might send to content server 212 a request 266 for the webpage, which was requested by the user.

Method 310 includes at step 316, receiving from the server the webpage together with ad-rendering instructions that, when executed, prompt retrieval of user-specific information of a user. For example, client 214 might receive from content server 212 the webpage 268 that was requested and ad-rendering instructions 270. Ad-rendering instructions 270 might be a copy of ad-rendering instructions 230, such that ad-rendering instructions 270 include a segment of instructions (i.e., code) that, when executed, prompt retrieval of user-specific information. For example, ad-rendering instructions 270 might be executed by instructions executor 234. Moreover, ad-rendering instructions 270 might be written pursuant to API 258, thereby enabling client 214 to interact with datastore 240 and access user-specific information 246.

At step 318, method 310 includes retrieving from a user-information datastore the user-specific information, which is accessible to the user when utilizing an online service of the online-service provider. For instance, when instructions executor 234 executes ad-rendering instructions 270, client 214 retrieves from online-service provider 216 user-specific information. In an embodiment of the present invention, approval must be gained to access user-specific information. For example, when a user sets up an online-service account, the user might agree to certain terms and conditions, which allow the ad-rendering instructions to prompt connection to the online-service provider and retrieval of user-specific information. As a result, approval is granted when the account is established and persists. In an alternative embodiment, when an advertisement is first presented to a user, the user might be prompted to input a login id and password, which allows subsequent access to the user-specific information. After such an initial authentication, login credentials might be stored in user cookies to persist the login information.

To illustrate retrieving user-specific information, FIG. 2 depicts an exemplary embodiment in which client 214 submits a request 272 for user-specific information, and in response, the requested user-specific information 274 is transmitted. Generally, user-specific information 274 includes information (e.g., images and textual items) to which the user has access when utilizing services of online-service provider 216. Exemplary textual items might include a date, a status, a relationship, a post, a comment, a location, an alma mater, an employer, a game, a preference, or a combination thereof. In this respect, user-specific information 274 is consistent with an access level of the user that applies to the user's utilization of online services. That is, in an embodiment of the present invention retrievable user-specific information is limited to information that is consistent with access rights of a user. As previously indicated, user-specific information 274 might include information classified under any of exemplary categories 248, 250, 252, 254, 256, and 257, or any other categories of information maintained in user-information datastore 240. Although FIG. 2 depicts user-information datastore 240 as a component of online-service provider 216, in other embodiments user-information datastore 240 might be maintained separately from online-service provider 216, such as on client device 214.

User-specific information 274 might include a plurality of potential ad-personalizing elements (e.g., images and/or items of text). As such, in one embodiment, instruction executor 234 applies a ranking algorithm to the user-specific information 274 to predict a most relevant subset of user-specific information. For example, the ranking algorithm might identify a linked user having a desired relevance to the user based on a relationship (e.g., wife, husband, fiancé, sister, brother, etc.) between the user and the linked user. In addition, the ranking algorithm might identify a relevant linked user based on how often the user and a linked user exchange messages (depicted under column 254) or how much duration has passed since a user last exchanged messages (depicted under column 256). Moreover, a ranking algorithm might identify a relevant linked user based on common user-specific information, such as when a user and a linked user share common favorites/preferences 257 (e.g., music, restaurants, etc.) and/or profile information (e.g., employer, education, etc.). These examples of filtering and ranking information are merely examples, and ad-rendering instructions are of a flexible nature, such that the ad-rendering instructions might be as simple or complex as an advertiser desires.

Step 320 includes customizing the advertisement to reflect the user-specific information, thereby generating a personalized advertisement. By customizing an ad to reflect user-specific information, a dynamic advertisement is generated in real time. For example, advertisement 262 has been customized to include an image 264 of the user's spouse that was included among user-specific information 274. However, image 264 could alternatively, or additionally, depict other individuals having a specified relationship to the user. For example, other images might programmably be included in advertisement 262, such as images that depict friends of the user, family of the user, and co-workers of the user. In addition to persons, advertisement 262 might be customized by adding images that represent other subject matter, such as a workplace of the user, an alma mater of the user, or a business entity patronized by the user. Moreover, advertisement 262 might be customized to present text having a personal connection to the user, such as a birthday, anniversary, or name. Advertisement 262 includes in italicized lettering text that could be personalized to be particularly relevant to the user. Advertisement 262 and the above examples are provided for illustrative purposes, and user-specific information that is usable to personalize an ad might include a wide variety of information accessible to the user through online-service provider 216.

At step 322, method 310 includes rendering the webpage together with the personalized advertisement. For example, browser 232 causes webpage 243 to be rendered together with advertisement 262 that is personalized to include an image 264 of the user's spouse.

Embodiments of the present invention might be utilized to generate various types of advertisements. Essentially, by leveraging user-specific information (e.g., 246), an advertiser can design ad-rendering instructions (e.g., 230) that hook with online-service provider APIs, thereby generating ads with elements that are based on the user's actual life. One exemplary advertisement might be designed by an advertiser of a networking service, which allows people that went to the same school to link up. Absent this invention, an advertisement might include several random pictures of individuals with whom a user has no personal connection and a message explaining that the pictured individuals reconnected using the networking service. However, using an embodiment of the present invention, the advertiser can design ad-rendering instructions pursuant to an online-service provider API, such that an ad generated client-side leverages actual images or digital avatars of user's friends who had gone to the same school as the user. Such an ad might have more user appeal then the ad generated absent this invention.

Another exemplary advertisement might be designed by a retailer wanting to advertise to a user in connection with an upcoming birthday of the user's spouse. Information that might be particularly relevant for such an advertisement includes an image of the spouse and the actual date of the birthday, both of which are often included among user-specific information. As such, the advertiser can design ad-rendering instructions pursuant to an online-service provider API, such that an ad generated client-side leverages an actual image of the spouse and the actual date of the spouse's birthday.

In another exemplary embodiment, ad-rendering instructions are written to interact with more than one online-service API. For example, ad-rendering instructions, when executed, might trigger retrieval of user-specific information from both a social-network provider and an e-commerce provider. In such an embodiment, user-specific information received from multiple online-service providers is merged, sorted, and/or ranked to dynamically generate a personalized advertisement in real time.

Various other exemplary advertisements are enabled using the present invention. As previously described, ad-rendering instructions can be designed to present any one of a plurality of ads and allow for customization upon retrieving user-specific information. For example, an embodiment of the present invention enables personalization of a credit-card advertisement. That is, an advertisement of a credit-card-service provider might be programmed to, when executed on a client device, retrieve from a user's account a quantity of points that have been earned by the user. The credit-card advertisement might present rewards or other items that the user can purchase using the points, as opposed to a generic ad with no rewards or with rewards that the user cannot purchase.

In a similar exemplary embodiment, an airline might design an advertisement to display a selection of destinations to which a user could fly using accrued airline mileage. That is, as previously described, the ad-rendering instructions might include a compilation of destinations. Retrieving accrued airline mileage from a user account allows the advertisement to be personalized to display only those destinations to which a user could fly using accrued airline mileage

In another exemplary embodiment, a video-game seller or online-gaming service might personalize an advertisement based on a user's video game successes and/or failures. For example, when a user is connected to Xbox Live® and is playing online against other players, results are tracked, such that an online-gaming service might personalize an ad, thereby suggesting that the user purchase an upgrade (e.g., weapon) to perform better in subsequent games.

Another exemplary advertisement might leverage user-specific information to advertise mobile-phone plans. For example, if a plan allows inclusion of selected persons, an advertisement for the mobile-phone plan might prompt retrieval of linked-users images (e.g., friend and family), such that the ad is presented with images of real friends and family members, as opposed to images of random individuals with whom the user has no connection.

A further exemplary advertisement might be customized to display particular retail items, depending on the user. For example, the ad might be customized based on a user's gender, occupation, age, location, or any other demographic information. That is, the advertisement might be served from an ad service with several different sale-item images (e.g., flowers, jewelry, home goods, sporting equipment, electronic devices, etc.); however, based on retrieved user-specific information (e.g., male, age 27, IT specialist), the ad might be customized to include a subset of images (e.g., electronic devices).

A further embodiment of the present invention includes a method of personalizing an advertisement, the method including receiving ad-rendering instructions that, when executed, prompt retrieval of user-specific information of a user. The method further includes retrieving from a user-information datastore the user-specific information. The advertisement is customized to include a personalized advertisement, which reflects the user-specific information. The personalized advertisement is caused to be rendered to the user.

Another embodiment of the present invention includes one or more computer-readable media having computer-executable instructions embodied thereon that, when executed by a client computing device, facilitate a method of personalizing an advertisement. The method includes receiving by the client computing device a request to render a webpage and sending by the client computing device a request to transmit the webpage. The method also includes receiving from a server the webpage together with ad-rendering instructions that, when executed, prompt retrieval of user-specific information of a user. The user-specific information, which is accessible to the user when utilizing an online service, is retrieved from a user-information datastore. The method further includes customizing the advertisement to include a presentation of the user-specific information, thereby generating a personalized advertisement, and rendering the webpage together with the personalized advertisement.

An additional embodiment of the present invention includes one or more computer-readable media having computer-executable instructions embodied thereon that, when executed by a computing device, facilitate a method of personalizing an advertisement. The method includes receiving a webpage together with ad-rendering instructions, which prompt retrieval of user-specific information of a user, and retrieving the user-specific information, which is accessible to the user when utilizing an online service. The user-specific information that is retrieved is ranked to identify most relevant user-specific information, and the advertisement is customized to reflect the most relevant user-specific information, thereby generating a personalized advertisement. The webpage is rendered together with the personalized advertisement.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of personalizing an advertisement, the method comprising:
receiving ad-rendering instructions that, when executed, prompt retrieval of user-specific information of a user;
retrieving from a user-information datastore the user-specific information;
customizing the advertisement to include a personalized advertisement, which reflects the user-specific information; and
causing the personalized advertisement to be rendered to the user.

2. The method of claim 1, wherein the ad-rendering instructions are received and executed by a client device, thereby maintaining privacy of the user-specific information that is retrieved.

3. The method of claim 1, wherein the ad-rendering instructions include a segment of instructions that are written pursuant to an application programming interface (“API”) and that enable retrieval of the user-specific information from the user-information datastore.

4. The method of claim 3, wherein the API is a social-network API that enables retrieval of the user-specific information from the user-information datastore, which is maintained by a social-network provider.

5. The method of claim 1, wherein the user-specific information includes information that is accessible to the user when utilizing an online service.

6. The method of claim 5, wherein the information is accessible to the user through an online-service account that allows utilization of the online service.

7. The method of claim 6, wherein the online-service account includes an email account, a social-network account, an instant-message account, an e-commerce account, an e-banking account, an e-investing account, a credit-card account, a gaming account, or a combination thereof.

8. The method of claim 1, wherein the user-specific information includes an image, an item of text, or a combination thereof.

9. The method of claim 1, wherein reflecting the user-specific information in the advertisement includes visually presenting the user-specific information as an element of the advertisement, selecting a version of the advertisement that targets a given user associated with the user-specific information, or a combination thereof.

10. One or more computer-readable media having computer-executable instructions embodied thereon that, when executed by a client computing device, facilitate a method of personalizing an advertisement, the method comprising:
receiving by the client computing device a request to render a webpage;
sending by the client computing device a request to transmit the webpage;
receiving from a server the webpage together with ad-rendering instructions that, when executed, prompt retrieval of user-specific information of a user;
retrieving from a user-information datastore the user-specific information, which is accessible to the user when utilizing an online service;
customizing the advertisement to include a presentation of the user-specific information, thereby generating a personalized advertisement; and
rendering the webpage together with the personalized advertisement.

11. The one or more computer readable media of claim 10, wherein the user-specific information includes an image that represents a subject and that is viewable by the user when the user is utilizing the online service.

12. The one or more computer readable media of claim 11, wherein the subject is a friend of the user, a spouse of the user, a family member of the user, or a combination thereof.

13. The one or more computer readable media of claim 11, wherein the subject is a workplace of the user, an alma mater of the user, a business entity patronized by the user, or a combination thereof.

14. The one or more computer readable media of claim 10, wherein the online service includes a social-network service, an email service, an instant-message service, an e-commerce service, an e-banking service, an e-investing service, a credit-account management service, a gaming service, or a combination thereof.

15. The one or more computer readable media of claim 10, wherein, when the user-specific information includes a plurality of potential ad-personalizing elements, the plurality is ranked to select a set of most relevant user-specific information.

16. The one or more computer readable media of claim 10, wherein the user-specific information includes an item of text that represents information accessible to the user when the user is utilizing the online service, and wherein the item of text is displayed as an element of the personalized advertisement.

17. The one or more computer readable media of claim 10, wherein the ad-rendering instructions include a segment of instructions that are written pursuant to an application programming interface (“API”) and that enable retrieval of the user-specific information from the user-information datastore, which is maintained by a online-service provider.

18. The method of claim 17, wherein the API is a social-network API, which enables retrieval of the user-specific information from the user-information datastore, which is maintained by a social-network provider.

19. One or more computer-readable media having computer-executable instructions embodied thereon that, when executed by a computing device, facilitate a method of personalizing an advertisement, the method comprising:
receiving a webpage together with ad-rendering instructions, which prompt retrieval of user-specific information of a user;
retrieving the user-specific information, which is accessible to the user when utilizing an online service;
ranking the user-specific information that is retrieved to identify most relevant user-specific information;
customizing the advertisement to reflect the most relevant user-specific information, thereby generating a personalized advertisement; and
rendering the webpage together with the personalized advertisement.

20. The one or more computer-readable media of claim 19, wherein the ad-rendering instructions include a segment of instructions that are written pursuant to an application programming interface (“API”) and that enable retrieval of the user-specific information from the user-information datastore.
